(19) United States
(12) Patent Application Publication
(10) Pub. No.: US 2012/0069067 A1
(43) Pub. Date: Mar. 22, 2012

(54) PRINTING APPARATUS AND METHOD FOR CONTROLLING PRINTING APPARATUS

(75) Inventors: Makoto Torigoe, Tokyo (JP); Shigeyasu Nagoshi, Yokohama-shi (JP); Yoshiaki Murayama, Tokyo (JP); Satoshi Azuma, Kawasaki-shi (JP); Kei Kosaka, Yokohama-shi (JP)

(73) Assignee: CANON KABUSHIKI KAISHA, Tokyo (JP)

(21) Appl. No.: 12/963,664

(22) Filed: Dec. 9, 2010

(30) Foreign Application Priority Data
Sep. 17, 2010 (JP) 2010-209558

(51) Int. Cl. B41J 29/38; G06K 15/02

(52) U.S. Cl. 347/6; 358/1.2

(57) ABSTRACT

According to the present invention, each printing head includes chips wherein a plurality of nozzles are prepared. The density of dots formed by ejecting ink from the nozzles is detected for each chip, and when a density difference between the chips is smaller than a predetermined value, print data are corrected, and the number of dots is adjusted so as to reduce the density difference. When the density difference is equal to or greater than the predetermined value, first, a drive pulse for the nozzles is modulated and the volume of ink to be ejected for one dot is adjusted so as to reduce the density difference. Thereafter, the print data is corrected, and the number of dots to be formed is controlled so as to reduce the density difference.

### BACKGROUND OF THE INVENTION

1. Field of the Invention

The present invention relates to a printing apparatus for printing images by forming dots on a printing medium, and to a method for controlling the printing apparatus during this process. More particularly, the invention relates to a printing apparatus that can reduce density unevenness of a printed image, and to a method for controlling the printing apparatus during this process.

2. Description of the Related Art

Such a printing apparatus includes a full-line type of printing apparatus that prints an image on a printing medium by relatively movement of an elongated printing head and the printing medium in one direction, the length of the printing head being almost the same as (or slightly greater than) the width of the printing medium. For this type of printing apparatus, however, print density for a plurality of printing elements provided with the elongated printing head may vary because there are variations in the finished products. Therefore, when these printing elements are employed to print an image based on uniform print data, an even density of the printed image may not be obtained, due to the manufacturing variations of the printing elements, and uneven density may occur.

For controlling the occurrence of uneven density, a head shading (HS) method, described in Japanese Patent Laid-Open No. H10-013674 (1998), is known. According to this method, for a printing head that includes a plurality of ink ejection nozzles as printing elements, information (ink volume information) related to the volume of ink to be ejected from each nozzle is obtained. Based on this ink volume information, print data for corresponding nozzles is corrected, and as a result, the number of ink droplets (corresponding to the number of dots to be formed) to be ejected from each nozzle is adjusted.

However, according to the HS method whereby the number of dots to be formed is adjusted, when the margin for adjusting the number of dots to be formed is increased to reduce the occurrence of uneven density, a difference in the number of dots formed in a unit area would be identified directly as a spatial difference. As a result, for a human being, this tends to appear to be an uneven density. Furthermore, for a printing apparatus that prints a multi-color image, an expected color range may not be expressed. Therefore, with the HS method for adjusting the number of dots to be formed, there is a limitation on the range available for preventing the occurrence of uneven density. Even assuming that another correction method is employed in addition to the HS method, an additional correction process must be performed, and throughput will be greatly reduced while printing costs will be raised sharply.

### SUMMARY OF THE INVENTION

The present invention provides a printing apparatus with which an increase in the number of processing steps is suppressed and a density unevenness of an image printed by forming dots can be efficiently and appropriately controlled, and a method for controlling the printing apparatus.

In the first aspect of the present invention, there is provided a printing apparatus configured to print an image on a printing medium by using a printing head comprising a plurality of printing elements able to form dots on the printing medium, and by driving the plurality of printing elements in accordance with a drive pulse generated based on print data, the printing apparatus comprising:
a first correction unit configured to be able to correct the print data so as to adjust the number of dots to be formed by the printing elements in a unit print area;
a second correction unit configured to be able to modulate the drive pulse for the printing element so as to adjust densities of dots formed by the printing elements; and
a density correction control unit configured to, when a difference in print densities among the plurality of printing elements is smaller than a predetermined value, permit the first correction unit to correct the print data for reducing the difference, and, when the difference in the print densities is greater than the predetermined value, permit the second correction unit to modulate the drive pulse for reducing the difference in the print densities, and thereafter permit the first correction unit to correct the print data for reducing the difference in the print densities.

In the second aspect of the present invention, there is provided a control method for controlling a printing apparatus configured to print an image on a printing medium by using a printing head comprising a plurality of printing elements able to form dots on the printing medium, and by driving the plurality of printing elements in accordance with a drive pulse generated based on print data, comprising:
a first correction step of correcting the print data so as to adjust the number of dots to be formed by the printing elements in a unit print area;
a second correction step of modulating the drive pulse for the printing element so as to adjust densities of dots formed by the printing elements; and
a density correction control step of, when a difference in print densities among the plurality of printing elements is smaller than a predetermined value, performing a process at the first correction step to correct the print data for reducing the difference, and, when the difference in the print densities is greater than the predetermined value, performing a process at the second correction step to modulate the drive pulse for reducing the difference in the print densities, and thereafter performing the process at the first correction step to correct the print data for reducing the difference in the print densities.

According to the present invention, density unevenness of an image that is printed by forming dots can be efficiently and appropriately controlled, without causing a great reduction in throughput and a sharp rise in printing costs.

Further features of the present invention will become apparent from the following description of exemplary embodiments (with reference to the attached drawings).

### BRIEF DESCRIPTION OF THE DRAWINGS

FIG. 1 is a plan view of the essential part of a printing apparatus according to a first embodiment of the present invention;

FIG. 2 is a schematic side view of the vicinity of a scanner shown in FIG. 1;

FIG. 3 is a block diagram illustrating the configuration of a printing system, including the printing apparatus in FIG. 1;

FIG. 4 is a schematic diagram illustrating the structure of a printing head in FIG. 1;

FIG. 5 is a flowchart for explaining uneven density correction processing performed by the printing apparatus in FIG. 1;

FIG. 6 is a diagram for explaining a printed example of a test pattern used for uneven density correction;

FIG. 7 is a diagram for explaining a relationship between the first HS correction and the second HS correction; and

FIG. 8 is a diagram for explaining the drive pulse of a heater.

### DESCRIPTION OF THE EMBODIMENTS

### First Embodiment

The preferred embodiments of the present invention will now be described while referring to the accompanying drawings. Hereinafter, an example will be explained where the present invention is applied for a full-line type of inkjet printing apparatus that prints a color image using an elongated inkjet printing head. The present invention can also be applied for a serial scan type inkjet printing apparatus that moves a printing head and a printing medium relative to each other, in a main scanning direction and in a sub scanning direction. Further, the present invention is not limited to an inkjet printing type, and can also be applied for another type, such as an electrophotographic type, of a printing apparatus. In short, any type of printing apparatus is available so long as a printing head includes a plurality of printing elements with which dots can be formed on a printing medium.

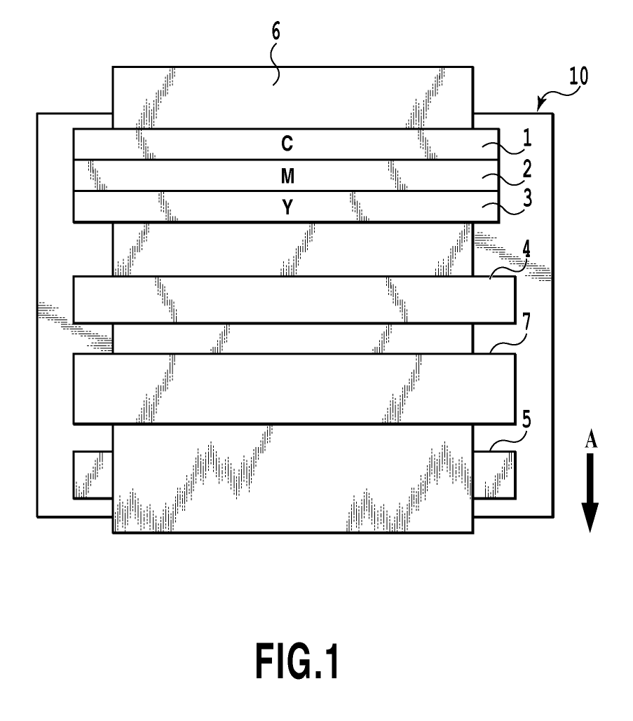

FIG. 1 is a plan view of the essential portion of an inkjet printing apparatus that can print a color image. A main body 10 of an inkjet printing apparatus includes: inkjet printing heads 1, 2 and 3 for ejecting cyan (C), magenta (M) and yellow (Y) inks; and a line feed motor 5 for conveying a printing sheet (printing medium) 6 in a direction indicated by an arrow A. An image scanner (hereinafter simply referred to as a scanner) 7 scans images that are printed on the printing sheet 6 by the printing heads 1, 2 and 3, and outputs the scanning results as detection signals for three colors, red (R), green (G) and blue (B). A pair of conveying rollers 4 hold the printing sheet 6 from both sides to maintain a gap between the scanner 7 and the printing sheet 6.

The printing heads 1, 2 and 3 in this embodiment each include a plurality of nozzles (printing elements) through which ink can be ejected. For individual C, M and Y inks, these nozzles are arranged to form nozzle arrays that are extended transverse to (in this embodiment, perpendicular to) the direction in which the printing sheet 6 is to be conveyed. In addition to these printing heads (also called “elongated heads”) that eject C, M and Y inks, a printing head for ejecting black (B) ink is also prepared for many printing apparatuses. For simplification of the explanation, the printing apparatus for this embodiment includes only the printing heads 1, 2 and 3 that eject C, M and Y inks. Further, various types of ejection energy generating elements, such as electrothermal conversion elements (heaters) or piezoelectric elements, can be employed by the printing heads to eject ink. When the electrothermal conversion element is employed, ink is heated until bubbling by heat supplied by the electrothermal conversion element, and using the energy thus produced, ink can be ejected from an ejection port formed at the distal end of the nozzle.

With this arrangement for the printing apparatus, when the printing heads 1, 2 and 3 have ejected ink once, an image for one raster is printed. Then, when the line feed motor 5 sequentially conveys the printing sheet 6 in the direction indicated by the arrow A, and the printing heads 1, 2 and 3 synchronously repeat the ink ejection procedure, an image for one page will be printed on the printing sheet 6.

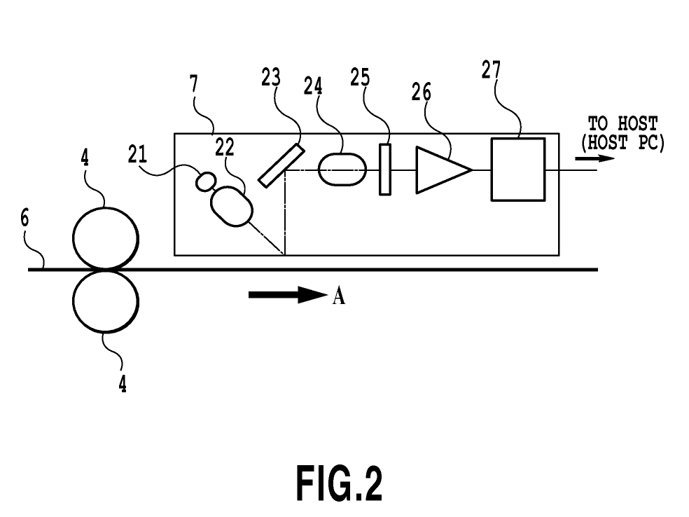

FIG. 2 is a side view of the vicinity of the scanner 7. A printing sheet 6, positioned facing the scanner 7, is conveyed by the conveying rollers 4 while maintaining a specific distance from the scanner 7. The scanner 7 includes, as a light source, a white LED 21 that outputs, as a continuous spectrum, visible light exhibiting a wavelength of about 400 to 700 nm. The light emitted by the light source 21 is formed into a line by alight guide element 22, and scans the plane of the printing sheet 6. The light is diffusely reflected from the printing sheet 6, and part of the light is reflected by a reflection mirror 23 and then passes through a reduced image forming lens 24, so that a reduced size image of an image printed on the printing sheet 6 is formed on a linear CCD 25.

The linear CCD 25 includes a predetermined number of pixels, e.g. about 600 dpi for a printing sheet 6, that are located within a range equivalent to a size obtained by reducing, at a reduction rate β of the imaging lens 24, the scanning width of the scanner that corresponds to the width of the printing sheet 6. These pixels form three pixel arrays that are covered with R, G and B color filters, and respectively output scan signals for R, G and B components. An amplifier 26 amplifies these signals, and an A/D converter 27 converts the resultant signals into digital signals. With this arrangement, the scanner 7 scans a one-dimensional image on the printing sheet 6 in the direction of the width (main scanning direction) that matches the longitudinal direction of the printing heads 1, 2 and 3, and outputs, as RGB data for the individual pixels, one-dimensional digital signals obtained by the scanning. When the printing sheet 6 is conveyed in the direction indicated by the arrow A (the sub scanning direction) and the scanning operation for a one-dimensional image is repeated at a predetermined interval, such as every 600 dpi on the printing sheet 6, a two-dimensional digital signal is obtained as a result of scanning the printing sheet 6. This two-dimensional digital signal is transmitted to a host apparatus (a host PC) 30, which will be described later.

The scanner 7 in this embodiment is a system wherein a sensor is employed to split the scanning light into R, G and B. However, the scanner 7 is not limited to this type, and LEDs of RGB (red , green and blue light) may be employed as light sources and may be switched over when the printing sheet 6 is conveyed a distance equivalent to one pixel in order to change the scanning order. Further, instead of employing the reduced image forming lens 24 as an optical imaging system, a SELFOC(Registered Trademark) Lens Array, which is an equal magnification optical imaging system, may also be employed. Furthermore, while the scanner 7 in this embodiment is incorporated into the printing apparatus, such a scanner may be provided separately from the printing apparatus.

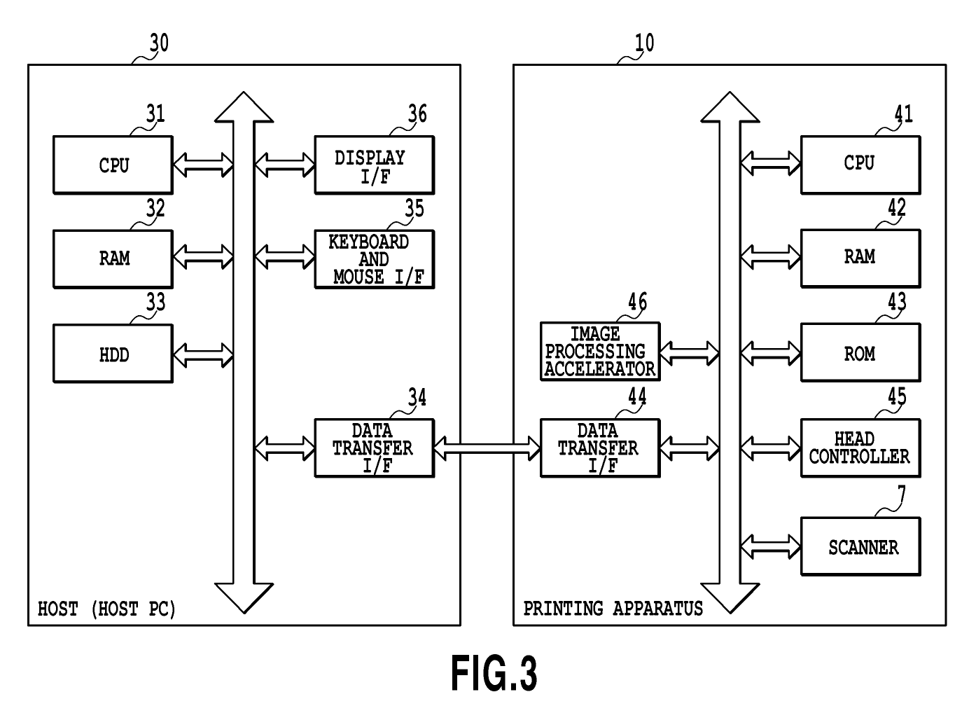

FIG. 3 is a block diagram illustrating the configuration of a control system for the printing apparatus and the host apparatus 30.

In the host apparatus 30, a CPU 31 performs the processing based on a program stored on an HDD 33 or in a RAM 32. The RAM 32 is a volatile storage device in which programs and data are temporarily stored, and the HDD 33 is a nonvolatile storage device, on which programs and data are stored. A data transfer I/F 34 transmits data to, or receives data from, the main body 10 of the printing apparatus. The individual blocks in the host apparatus 30 are physically connected by a USB/IEEE1394/LAN, for example. A keyboard or mouse I/F 35 is an I/F that controls a human interface device (HID), such as a keyboard or a mouse, for accepting an entry by a user, and a display I/F 36 is an I/F that functions with a display device.

In the main body 10 of the printing apparatus, a CPU 41 performs processing based on a program stored in a ROM 43 or a RAM 42. The RAM 42 is a volatile storage device on which a program and data are temporarily stored, and the ROM 43 is a nonvolatile storage device in which a program and data are stored. A data transfer I/F 44 transmits data to, or receives data from, the host apparatus 30. The individual blocks in the printing apparatus are physically connected by a USB/IEEE1394/LAN, for example.

A head controller 45, which supplies print data to the printing heads 1, 2 and 3 to control printing, may be so designed that it reads required parameters and data at a predetermined address in the RAM 42. In this case, when the CPU 41 has written required parameters and data at the predetermined address in the RAM 42, the head controller 45 is started. An image processing accelerator 46 for performing the image processing faster than the CPU 41 may be so designed that it, for example, reads required parameters and data at a predetermined address in the RAM 42. In this case, when the CPU 41 has written required parameters and data at the predetermined address on the RAM 42, the image processing accelerator 46 is started. The image processing accelerator 46 is not always required, however, and the image processing may be performed by using only the CPU 41. Furthermore, the nozzles prepared in the printing heads 1, 2 and 3 are driven by a drive pulse that is generated based on the print data.

The image processing performed under the control of the CPU 41 includes the head shading (HS) processing for reducing difference in print densities (uneven density) provided by a plurality of nozzles. The HS process includes first and second correction methods. The first correction method (hereinafter also referred to as “first HS correction”) is a method for adjusting the number of ink droplets to be ejected from each of the nozzles (corresponding to the number of dots to be formed in the unit area for printing). The second correction method (hereinafter referred to as “second HS correction”) is a method for adjusting the volume of ink to be ejected (the volume of ink required to form one dot).

For performing the first HS correction for adjusting the number of ink droplets to be ejected from each nozzle (corresponding to the number of dots to be formed), print data is corrected to reduce difference in print densities provided by the individual nozzles, as described in Japanese Patent Laid-Open No. H10-013674 (1998). According to this embodiment, as will be described later, the first HS correction is performed for each area, so that uniform densities are obtained among the areas that include a plurality of nozzles. The main body 10 of the printing apparatus includes a first correction processor that performs such a first HS correction process under the control of the CPU 41. The first correction processor may be included in the image process accelerator 46, or a part of this processor may be prepared in the host apparatus 30.

For the second HS correction for adjusting the volume of ink to be ejected from each nozzle, drive pulses for the nozzles are modulated. In this embodiment, as will be described later, for each area that includes a plurality of nozzles, PWM control is performed for the drive pulses of electrothermal conversion_elements (heaters) that are provided as ejection energy generating elements. Therefore, the main body 10 of the printing apparatus includes a second correction processor that can modulate drive pulses (in this embodiment, can perform PWM control for drive pulses) under the control of the CPU 41. The second correction processor may be included in the image processing accelerator 46, or a part of the second correction processor may be prepared for the host apparatus 30. Furthermore, the main body 10 of the printing apparatus includes a density correction controller that, as will be described later, controls the first and second HS correction processors, in correlation with each other, under the control of the CPU 41. A part of the density correction controller may be prepared in the host apparatus 30.

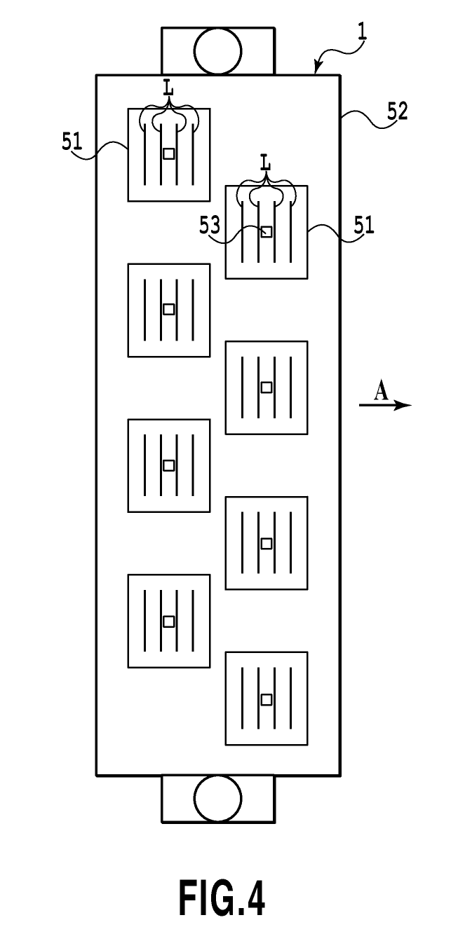

FIG. 4 is a diagram for explaining an example structure for a printing head. Since the same structure is employed for the printing heads 1, 2 and 3, only the printing head 1 is shown as a model.

Chips 51 are formed of silicon, and on the individual chips 51, nozzle arrays L, each consisting of a plurality of nozzles, are extended transverse to (in this embodiment, perpendicular to) the direction indicated by an arrow A. The length (effective ejection width) of each nozzle array L is about one inch. For this embodiment, four nozzle arrays L are formed in parallel on each chip 51. Eight of the chips 51 are adhered, in a zigzag pattern, to a lower base substrate 52 of the printing head 1, and are electrically connected, by wire bonding, to a flexible printed wiring board (not shown) via electrodes that are positioned at both ends of the lower base substrate 52. A temperature sensor 53 is included on each of the individual chips 51 to measure the temperature of the chip 51. Since the printing head 1 has eight chips 51, an effective ejection width of about eight inches is obtained, which length substantially matches the length of the short side (width) of an A4 printing sheet. Therefore, when the A4 printing sheet is fed in the longitudinal direction, an image can be sequentially printed on the printing sheet. Thus, when the ejection of ink is performed by the printing heads 1, 2 and 3, all of which have the same structure, a full-color image can be printed.

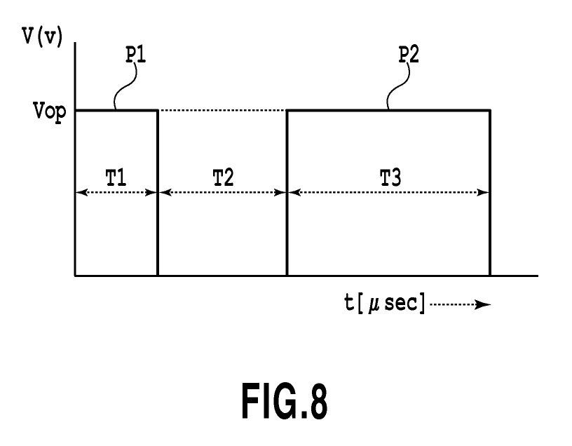

Each of the ejection ports is formed at the distal end of the nozzle and opens at the surface of the chip 51, and when ink is ejected through the ejection port and is impacted on the printing sheet 6 to form dots, an image is printed on the printing sheet 6. In this embodiment, electrothermal conversion elements (heaters) are employed as ink ejection energy generating elements, and are heated to form ink bubbles and eject ink droplets through the ejection ports. The general PWM control can be performed as a heater control method, and specifically, the volume of ink to be ejected can be controlled in accordance with the width of a drive pulse for the heater. As shown in FIG. 8, when a pre-pulse P1 that has a pulse width T1 and a main pulse P2 that has a pulse width T3 are applied to the heater, the volume of ink to be ejected can be controlled in accordance with an interval time T2 between these pulses. In this case, as described in Japanese Patent Laid-Open No. H05-169659 (1993), each of the temperature sensors 53 may be employed to detect the temperature of the chip 51, and current pulse to be applied to the heater may be controlled based on a PWM table corresponding to the detected temperature. The PWM table includes, for example, the entries PWM0 to PWM14, with PWM7 in the middle, and as a table entry number becomes greater, the energy to be supplied to the heater is increased. Since the volume of ink to be ejected varies depending on the temperature of the chip 51, so long as the drive pulse for the heater is controlled based on the temperature detected for the chip 51, a constant volume of ink can be maintained. In this embodiment, as will be described later, the PWM control of the heaters is performed for the second HS correction.

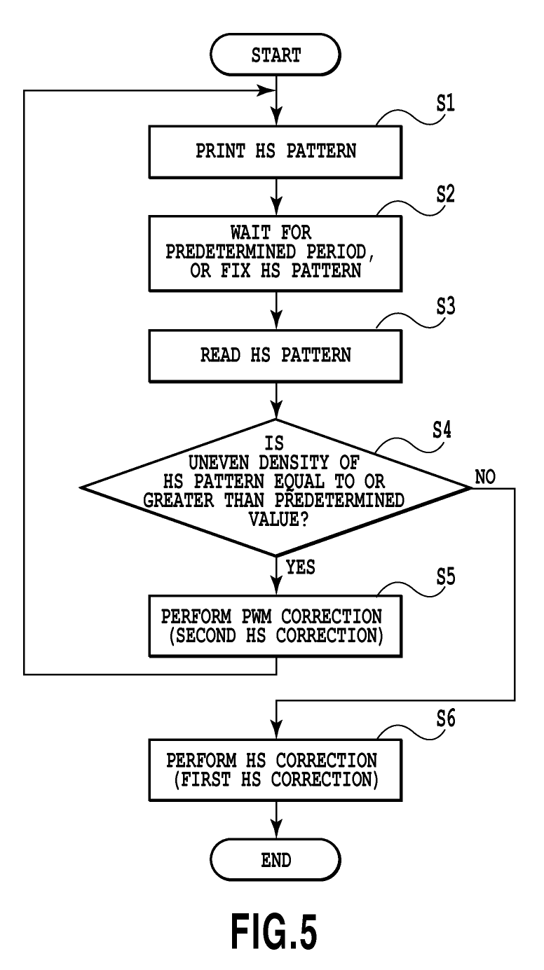

FIG. 5 is a flowchart for explaining a method for measuring the ejection characteristic of the nozzles.

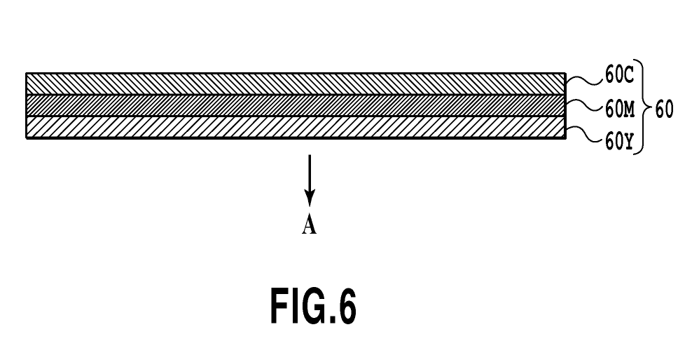

First, the printing heads 1, 2 and 3 are employed and a test pattern (HS pattern) for detecting a print density is printed on the printing sheet 6 (step S1). An example HS pattern is shown in FIG. 6. A pattern 60 in this example includes a pattern 60Y provided at a print duty of 50% by yellow ink, a pattern 60M provided at a print duty of 50% by magenta ink, and a pattern 60C provided at a print duty of 50% by cyan ink. The print duty is a rate at which ink covers the unit print area, and corresponds to the ratio of the number of ejected ink droplets to the maximum ink droplets available for the unit print area.

The correction by head shading (HS) for suppressing the occurrence of uneven density, i.e. an HS correction, may be performed for the individual pixels that correspond to the nozzles of the printing heads. For the elongated printing heads, as in this embodiment, since the number of nozzles is increased and accordingly the period required for the data processing is extended, it is preferable that each area consisting of a plurality of pixels is regarded as one unit group, and that the HS correction is performed for each area. That is, the print area is divided into areas A1 to AN, where N denotes the number of areas. In this embodiment, chips are employed as area units. The size of each area is determined to be equal to or smaller than half of a spatial frequency at which a user can visually recognize uneven density in a printed image. Therefore, the number N of areas is a value obtained by dividing the length of the nozzle array of the printing head by the length corresponding to the spatial frequency to be visually recognized.

The pattern 60, printed at step S1, is read by the pixels of the individual RGB sensor arrays (channels) of the scanner 7 (step S3). Especially, when dye ink is employed for printing the pattern 60, the color of the image is not immediately fixed after the pattern 60 has been printed. Therefore, during a process begun immediately following the printing of the pattern 60 and continuing until the image of the pattern 60 has been read, the pattern 60 image is fixed, as needed, by being untouched for a predetermined period of time, or by the use of a fixing device, such as a dryer (step S2). The values of the density data, obtained using the pixels of the individual RGB channels, are averaged for the individual areas A1 to AN, and an average density data value for each area (each chip) is obtained.

On the basis of the density data value (density value) for each area, HS correction is performed for each area to obtain density uniformity for the individual areas. As is described above, there is a limitation on the use of the first HS correction whereby the number of dots to be formed is adjusted. Thus, at step S4, a check is performed to determine whether a difference in density values (uneven densities) in the areas of the pattern 60 is equal to or greater than a predetermined value that corresponds to a limiting value for the first HS correction. When the uneven density is smaller than the predetermined value, the first HS correction is performed, and thereafter the processing is terminated (step S6). When the uneven density is equal to or greater than the predetermined value, the uneven density cannot be resolved merely by performing the first HS correction, and the PWM correction, which will be described later, is performed for each chip 51, as the second HS correction (step S5).

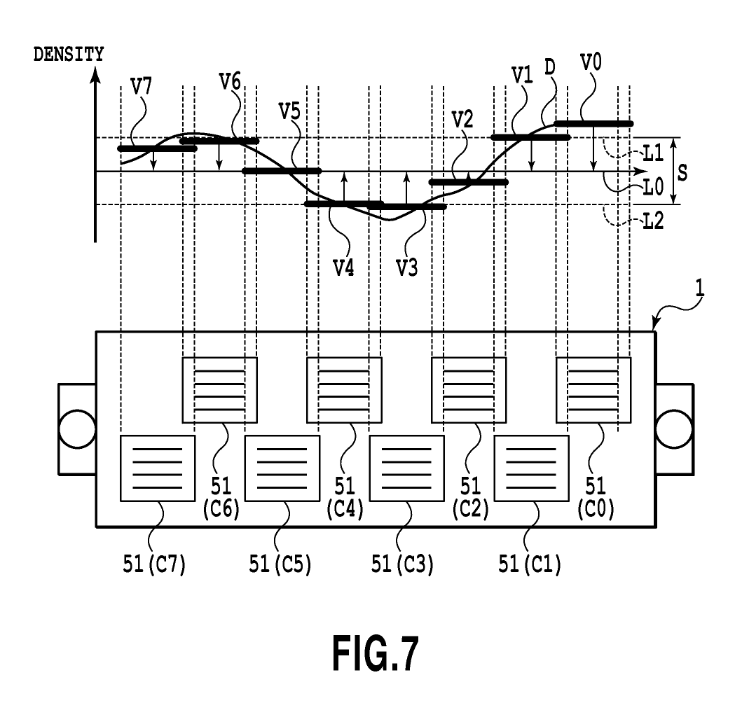

FIG. 7 is a diagram for explaining the PWM correction. A curve D, shown in the upper portion in FIG. 7, indicates a distribution of density values for the areas A1 to AN that are read at step S3, i.e., indicate uneven densities. When the eight chips 51 included in the printing head 1 denote C0, C1, C2, . . . and C7, a curve that connects the average density values V1, V2, V3, . . . and V7 for the individual chips is the curve D.

When a range between the density values L1 and L2 is an uneven density range (a predetermined value) S that can be corrected by the first HS correction, the curve D in FIG. 7 is equal to or greater than the predetermined value S, and uneven densities, indicated by the curve D, cannot be corrected simply by performing the first HS correction. In this case, the second HS correction (a PWM correction) is performed for each chip, so that the average density values V1, V2, V3, . . . and V7, for the individual chips, are equal to the middle value (median) L0 of the density values L1 and L2. That is, for a chip whose density value is higher than the median L0, PWM control is performed for a drive pulse for this chip, so that a smaller volume of ink is ejected from the chip. For a chip whose density value is lower than the median L0, PWM control is performed for a drive pulse for this chip, so that a larger amount of ink is ejected from the chip.

Based on the drive pulse obtained by the second HS correction, the HS pattern 60 is printed again (step S1). Sequentially, thereafter, the HS pattern 60 is fixed and scanned (step S2 and 53), and the check is again performed to determine whether a difference in density values (uneven densities) of the individual areas for the pattern 60 is equal to or greater than the predetermined value S, which corresponds to the limiting value for the first HS correction (step S4). When the uneven density is smaller than the predetermined value S, the first HS correction is performed, and thereafter, the processing is terminated (step S6). When the uneven density is equal to or greater than the predetermined value S, the second HS correction is repeated (step S5). For a case wherein it is apparent that the uneven density will be smaller than the predetermined value S, as a result of the first performance of the second HS correction, the second determination process at step S4 is not necessarily performed.

### Other Embodiment

The nozzle usage histories, such as the ink ejection frequencies, for the individual areas A1 to AN, may be obtained to designate the time for starting the HS correction. That is, when the value of a variance in the nozzle usage histories for the areas A1 to AN, which corresponds to a difference in ink ejection frequencies, becomes equal to or greater than a predetermined value, it can be determined that there is a possibility that an uneven density has occurred due to deterioration of the nozzles. Therefore, this time may be designated as time for starting the HS correction. Furthermore, the usage history may be obtained for the individual nozzles, and when a variance in the usage history for each nozzle is equal to or greater than a predetermined value, the HS correction may be started. That is, the usage histories, including the usage frequencies for a predetermined number of printing elements, are obtained, and when a variance in the usage histories of these printing elements reaches a predetermined value or greater, it can be determined that a period for performing the above described HS correction (a period during which to start the density correction unit) has arrived.

Furthermore, when an uneven density is equal to or greater than a predetermined threshold value S (see FIG. 7), and cannot be lowered further than the threshold value S, by performing both the first HS correction and the second HS correction (a PWM correction), it may be determined that the service life of the printing head has expired. When such a decision is obtained, the user of the printing apparatus may be requested to replace the printing head, or a call for a repairman may be automatically placed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-209558, filed Sep. 17, 2010, which is hereby incorporated by reference herein in its entirety.

What is claimed is:

1. A printing apparatus configured to print an image on a printing medium by using a printing head comprising a plurality of printing elements able to form dots on the printing medium, and by driving the plurality of printing elements in accordance with a drive pulse generated based on print data, the printing apparatus comprising:
a first correction unit configured to be able to correct the print data so as to adjust the number of dots to be formed by the printing elements in a unit print area;
a second correction unit configured to be able to modulate the drive pulse for the printing element so as to adjust densities of dots formed by the printing elements; and
a density correction control unit configured to, when a difference in print densities among the plurality of printing elements is smaller than a predetermined value, permit the first correction unit to correct the print data for reducing the difference, and, when the difference in the print densities is greater than the predetermined value, permit the second correction unit to modulate the drive pulse for reducing the difference in the print densities, and thereafter permit the first correction unit to correct the print data for reducing the difference in the print densities.

2. The printing apparatus according to claim 1, further comprising:
a printing control unit configured to, by using the plurality of printing elements, print a test pattern for print density detection;
a reading unit configured to read the test pattern for print density detection; and
a detection unit configured to detect the difference in the print densities based on the results obtained by the reading unit.

3. The printing apparatus according to claim 2, wherein the printing control unit is able to print the test pattern for print density detection based on the drive pulse modulated by the second correction unit.

4. The printing apparatus according to claim 2, wherein the printing control unit is able to print the test pattern for print density detection based on the drive pulse modulated by the second correction unit and the print data corrected by the first correction unit.

5. The printing apparatus according to claim 4, further comprising:
a determination unit configured to determine that the service life of the printing head has expired, when the difference in the print densities in the test pattern, which was printed for print density detection based on the drive pulse modulated by the second correction unit and the print data corrected by the first correction unit, is greater than the predetermined value.

6. The printing apparatus according to claim 2, further comprising:
an acquisition unit configured to obtain a usage history including a frequency for the use of every predetermined number of printing elements; and
a determination unit configured to, when a value for a variance in the usage history becomes equal to or greater than a predetermined value, determine that a period for starting the density correction control unit has arrived.

7. The printing apparatus according to claim 1, wherein for each of a plurality of areas that are obtained by dividing a print region to be printed by the plurality of printing elements, the first correction unit corrects the print data corresponding to the printing elements.

8. The printing apparatus according to claim 1, wherein for each of the plurality of areas that are obtained by dividing a print region to be printed by the plurality of printing elements, the second correction unit modulates the drive pulse for the printing elements.

9. The printing apparatus according to claim 1, wherein the printing head is an inkjet printing head that includes, as the printing elements, nozzles from which ink can be ejected, and
the second correction unit modulates the drive pulse for the printing elements to adjust the volume of ink to be ejected.

10. A control method for controlling a printing apparatus configured to print an image on a printing medium by using a printing head comprising a plurality of printing elements able to form dots on the printing medium, and by driving the plurality of printing elements in accordance with a drive pulse generated based on print data, comprising:
a first correction step of correcting the print data so as to adjust the number of dots to be formed by the printing elements in a unit print area;
a second correction step of modulating the drive pulse for the printing element so as to adjust densities of dots formed by the printing elements; and
a density correction control step of, when a difference in print densities among the plurality of printing elements is smaller than a predetermined value, performing a process at the first correction step to correct the print data for reducing the difference, and when the difference in the print densities is greater than the predetermined value, performing a process at the second correction step to modulate the drive pulse for reducing the difference in the print densities, and thereafter performing the process at the first correction step to correct the print data for reducing the difference in the print densities.
